(19) United States
(12) Patent Application Publication
(10) Pub. No.: US 2011/0261070 A1
(43) Pub. Date: Oct. 27, 2011

(54) METHOD AND SYSTEM FOR REDUCING REMOTE DISPLAY LATENCY

(76) Inventor: Peter Francis Chevalley De Rivaz, Cambridge (GB)

(21) Appl. No.: 12/794,866

(22) Filed: Jun. 7, 2010

Related U.S. Application Data
(60) Provisional application No. 61/327,553, filed on Apr. 23, 2010.

(51) Int. Cl. H04N 7/04; G09G 5/00

(52) U.S. Cl. 345/619; 348/469; 348/E07.04

(57) ABSTRACT

A multimedia communication device may be operable to divide each of created consecutive image frames into a first portion and a corresponding second portion. The first portion and the corresponding second portion for each of the consecutive image frames may be transmitted in a reversed order, via a wireless communication network, to a display device. Each of the divided plurality of consecutive image frames may be displayed on the display device in the transmitted reversed order. Each of the divided plurality of consecutive image frames may be displayed beginning with one of the transmitted first portion and ending with one of the transmitted corresponding second portion. The dividing of each of the created consecutive image frames may be determined based on user configuration of the multimedia communication device.

### CROSS-REFERENCE TO RELATED APPLICATIONS/INCORPORATION BY REFERENCE

This patent application makes reference to, claims priority to, and claims benefit from U.S. Provisional Application Ser. No. 61/327,553, which was filed on Apr. 23, 2010.

The above stated application is hereby incorporated herein by reference in its entirety.

### FIELD OF THE INVENTION

Certain embodiments of the invention relate to communication systems. More specifically, certain embodiments of the invention relate to a method and system for reducing remote display latency.

### BACKGROUND OF THE INVENTION

Image and video capabilities may be incorporated into a wide range of devices such as, for example, mobile phones, digital televisions, digital direct broadcast systems, digital recording devices, gaming consoles and the like. The processing of video data, however, may be very computationally intensive because of the large amounts of data that need to be constantly processed. This normally requires systems with powerful processors, hardware accelerators, and/or substantial memory, particularly when video encoding is required. Such systems may typically use large amounts of power, which may make them less than suitable for certain applications, such as mobile applications.

Due to the ever growing demand for image and video capabilities, there is a need for power-efficient, high-performance multimedia processors that may be used in a wide range of applications, including mobile applications. Such multimedia processors such as, for example, the multimedia processors in multimedia communication devices may support multiple operations including audio processing, image sensor processing, video recording, media playback, graphics, three-dimensional (3D) gaming, and/or other similar operations.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for reducing remote display latency, substantially as shown in and/or described in connection with at least one of the FIGUREs, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary communication system that is operable to reduce remote display latency, in accordance with an embodiment of the invention.

FIG. 2 is a block diagram illustrating an exemplary multimedia system that is operable to reduce remote display latency, in accordance with an embodiment of the invention.

FIG. 3 is a block diagram illustrating an exemplary image frame which is displayed on a display device for reducing remote display latency, in accordance with an embodiment of the invention.

FIG. 4 is a flow chart illustrating exemplary steps for reducing remote display latency, in accordance with an embodiment of the invention.

FIG. 5 is a flow chart illustrating exemplary steps for a display device to display received image data for reducing remote display latency, in accordance with an embodiment of the invention.

### DETAILED DESCRIPTION OF THE INVENTION

Certain embodiments of the invention can be found in a method and system for reducing remote display latency. In various embodiments of the invention, a multimedia communication device may be operable to divide each of a plurality of consecutive image frames into a first portion and a corresponding second portion. The plurality of consecutive image frames may be created for display, for example, on a display device. In this regard, for example, the first portion may be an upper portion and the corresponding second portion may be a lower portion of an image frame. For each of the divided plurality of consecutive image frames, the first portion and the corresponding second portion may be transmitted, in a reversed order, to the display device by the multimedia communication device. Each of the divided plurality of consecutive image frames may be displayed on the display device in the transmitted reversed order. Each of the divided plurality of consecutive image frames may be displayed beginning with one of the transmitted first portion and ending with one of the transmitted corresponding second portion. Accordingly, each of the displayed image frames which are displayed on the display device may comprise a first portion and a corresponding second portion. The first portion of a displayed image frame may comprise a first portion of a created image frame which may be created at time T, for example. The corresponding second portion of the displayed image frame may then comprise a corresponding second portion of another created image frame which is consecutively created following the image frame that is created at time T. The multimedia communication device may be operable to format each of the plurality of consecutive image frames to enable display of the consecutive image frames in a transmission order, and to enable display of each of the divided plurality of consecutive image frames beginning with one of the first portion and ending with one of the corresponding second portion.

In an exemplary embodiment of the invention, the multimedia communication device may be operable to determine how to divide each of the created consecutive image frames into the first portion and the corresponding second portion, based on, for example, user configuration of the multimedia communication device. In this regard, each of the consecutive image frames created for display may comprise N lines of pixels, and each of the consecutive image frames displayed on the display device may also comprise N lines of pixels, for example. N is an integer that is greater than 1. Each of the first portions may comprise X lines of pixels and each of the corresponding second portions may comprise (N−X) lines of pixels, for example. X may be an integer that is greater than zero and smaller than N. In an exemplary embodiment of the invention, X may be determined based on the user configuration of the multimedia communication device. For example, X may be determined based on a ratio of X to N (X/N). A ratio of X to N (X/N) may be equal to one quarter (¼), one third (⅓) or one half (½), for example.

In an exemplary embodiment of the invention, the multimedia communication device may be operable to transmit the divided plurality of consecutive image frames to the display device via a wireless communication network. The wireless communication network may comprise, for example, a WiFi network, a WiMAX network and/or a cellular network.

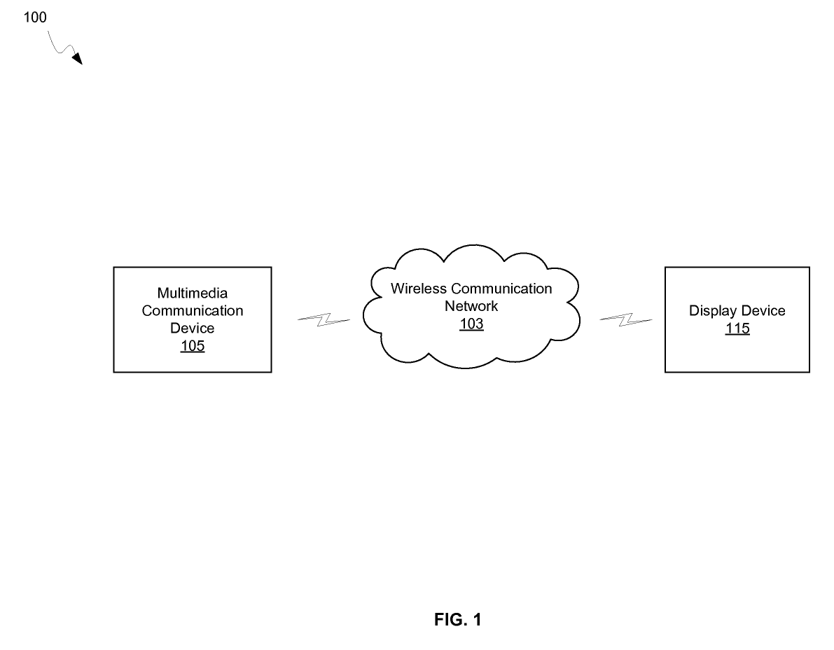

FIG. 1 is a block diagram illustrating an exemplary communication system that is operable to reduce remote display latency, in accordance with an embodiment of the invention. Referring to FIG. 1, there is shown a communication system 100. The communication system 100 may comprise a multimedia communication device 105, a wireless communication network 103 and a display device 115.

The multimedia communication device 105 may comprise suitable logic, circuitry, interfaces and/or code that may be operable to communicate radio signals across a wireless communication network such as the wireless communication network 103. The multimedia communication device 105 may be operable to process image, video and/or multimedia data. The multimedia communication device may comprise a game console, and/or a set-top box. In one embodiment of the invention, the game console may be integrated in the set-top box. In another embodiment of the invention, the set-top box may be integrated in the game console.

The multimedia communication device 105 may be operable to create a plurality of consecutive image frames for display on a display device such as, for example, the display device 115. For example, the multimedia communication device 105 may be a game console and the display device 115 may be coupled to it via a wireless or wired medium. The plurality of consecutive image frames may be created due to inputs from game controllers. The created consecutive image frames may then be transmitted to the display device 115 for a game player. A data stream of the created consecutive image frames may be transmitted via a wireless communication network such as, for example, the wireless communication network 103 from the multimedia communication device 105 to the display device 115. In this regard, there may be noticeable delay between a time when an image frame is created and the time when the image frame is displayed or seen on a screen of the display device 115. This latency may be due to, for example, data encoding, wireless network transmission and/or data decoding during the transmission of the data stream of the consecutive image frames over the wireless communication network 103.

In an exemplary embodiment of the invention, the multimedia communication device 105 may be operable to divide each of the created consecutive image frames into a first portion and a corresponding second portion. In this regard, for example, the first portion may be an upper portion and the corresponding second portion may be a lower portion of an image frame. For each of the divided plurality of consecutive image frames, the first portion and the corresponding second portion may be transmitted, in a reversed order, to the display device 115 by the multimedia communication device 105. Each of the divided plurality of consecutive image frames may be displayed on the display device 115 in the transmitted reversed order. Each of the divided plurality of consecutive image frames may be displayed beginning with one of the transmitted first portion and ending with one of the transmitted corresponding second portion. The multimedia communication device 105 may be operable to format each of the plurality of consecutive image frames to enable display of the consecutive image frames in a transmission order, and to enable display of each of the divided plurality of consecutive image frames beginning with one of the first portion and ending with one of the corresponding second portion.

In an exemplary embodiment of the invention, the multimedia communication device 105 may be operable to determine how to divide each of the created consecutive image frames into the first portion and the corresponding second portion, based on user configuration of the multimedia communication device 105. The user configuration of the multimedia communication device 105 may determine whether each of the created image frames may be divided into two portions, namely, the first portion and the corresponding second portion and/or how each of the created image frames may be divided proportionally.

The wireless communication network 103 may comprise suitable logic, circuitry, interfaces and/or code that may be operable to provide voice and data services to various communication devices such as the multimedia communication device 105 by using wireless or cellular communication technologies such as, for example, WCDMA, UMTS, HSDPA, CDMA, EV-DO, GSM, GPRS, EDGE, EGPRS, LTE, WiMAX and/or WiFi. In an exemplary embodiment of the invention, the wireless communication network 103 may be operable to provide communication service between the multimedia communication device 105 and the display device 115.

The display device 115 may comprise suitable logic, circuitry, interfaces and/or code that may be operable to display or present image frames created by the multimedia communication device 105. The display device 115 may receive the image data streams from the multimedia communication device 105 via, for example, the wireless communication network 103.

In operation, the multimedia communication device 105 may be operable to create a plurality of consecutive image frames for display on a display device such as, for example, the display device 115. The multimedia communication device 105 may be operable to divide each of the created consecutive image frames into a first portion and a corresponding second portion. In this regard, for example, the first portion may be an upper portion and the corresponding second portion may be a lower portion of an image frame. For each of the divided plurality of consecutive image frames, the first portion and the corresponding second portion may be transmitted, in a reversed order, to the display device 115 by the multimedia communication device 105, for example, via the wireless communication network 103. Each of the divided plurality of consecutive image frames may be displayed on the display device 115 in the transmitted reversed order. Each of the divided plurality of consecutive image frames may be displayed beginning with one of the transmitted first portion and ending with one of the transmitted corresponding second portion. The multimedia communication device 105 may be operable to format each of the plurality of consecutive image frames to enable display of the consecutive image frames in the order in which it was transmitted, and to enable display of each of the divided plurality of consecutive image frames beginning with one of the first portion and ending with one of the corresponding second portion.

Accordingly, each of the displayed image frames which are displayed on the display device 115 may comprise a first portion and a corresponding second portion. The first portion of a displayed image frame may comprise a first portion of a created image frame which may be created at time T, for example. The corresponding second portion of the displayed image frame may then comprise a corresponding second portion of another created image frame which is consecutively created following or next to the image frame that is created at time T. In this regard, the corresponding second portion of a created image frame may be displayed on the display device 115 one frame ahead of the first portion. Accordingly, a portion corresponding to the beginning of the corresponding second portion of a created image frame such as, for example, a portion near the middle of the created image frame, may be displayed or seen sooner than other portions of the created image frame. In some cases such as, for example, in a video game operation, an interesting part and/or an important part of an image frame may be near the middle of the image frame. A user may be more interested in things which are happening in the middle of the screen than what is happening near the top of the screen, for example. In this regard, a user may configure the multimedia communication device 105 to divide the created image frames based on a user's preference.

In an exemplary embodiment of the invention, the multimedia communication device 105 may be operable to determine how to divide each of the created consecutive image frames into the first portion and the corresponding second portion, based on user configuration of the multimedia communication device 105. The user configuration may determine whether each of the created image frames may be divided into two portions, namely, the first portion and the corresponding second portion and/or how each of the created image frames may be divided proportionally. In this regard, each of the consecutive image frames created for display may comprise N lines of pixels, and each of the consecutive image frames displayed on the display device may also comprise N lines of pixels, for example. Each of the first portions may comprise X lines of pixels and each of the corresponding second portions may comprise (N−X) lines of pixels, for example. X may be greater than zero and smaller than N. In an exemplary embodiment of the invention, X may be determined based on the user configuration of the multimedia communication device 105. For example, X may be determined based on a ratio of X to N (X/N). A ratio of X to N (X/N) may be equal to one quarter (¼), one third (⅓) or one half (½), for example, depending on a user's preference.

In instances when N is equal to 1080, for example. Each of the image frames may comprise 1080 lines of pixels. For the case where the ratio X/N is equal to ¼, the first portion of an image frame may comprise 270 lines of pixels and the corresponding second portion of an image frame may comprise 810 lines of pixels. For the case where the ratio X/N is equal to ⅓, the first portion of an image frame may comprise 360 lines of pixels and the corresponding second portion of an image frame may comprise 720 lines of pixels. For the case where the ratio X/N is equal to ½, the first portion of an image frame may comprise 540 lines of pixels and the corresponding second portion of an image frame may comprise 540 lines of pixels.

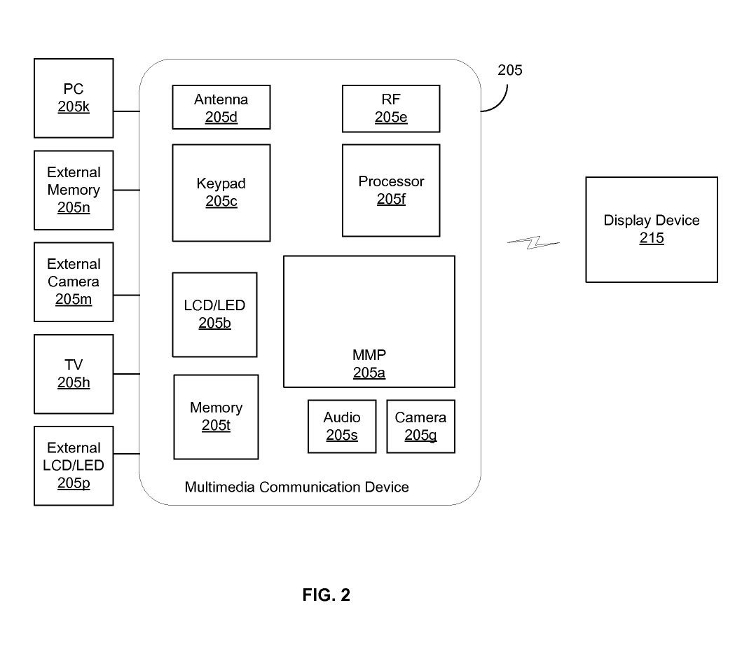

FIG. 2 is a block diagram illustrating an exemplary multimedia system that is operable to reduce remote display latency, in accordance with an embodiment of the invention. Referring to FIG. 2, there is shown a multimedia communication device 205, a TV 205h, a PC 205k, an external camera 205m, an external memory 205n, an external LCD or LED display 205p and a display device 215. The display device 215 may be substantially similar to the display device 115 in FIG. 1.

The multimedia communication device 205 may be substantially similar to the multimedia communication device 105 in FIG. 1. The multimedia communication device 205 may comprise a mobile multimedia processor (MMP) 205a, a memory 205t, a processor 205f, an antenna 205d, an audio block 205s, a radio frequency (RF) block 205e, an LCD or LED display 205b, a keypad 205c, a camera 205g.

The mobile multimedia processor (MMP) 205a may comprise suitable logic, circuitry, interfaces, and/or code that may be operable to perform image, video and/or multimedia processing for the multimedia communication device 205. For example, the MMP 205a may be designed and optimized for video record/playback, mobile TV and 3D mobile gaming. The MMP 205a may perform a plurality of image processing techniques such as, for example, filtering, demosaic, lens shading correction, defective pixel correction, white balance, image compensation, Bayer interpolation, color transformation and post filtering. The MMP 205a may also comprise integrated interfaces, which may be utilized to support one or more external devices coupled to the multimedia communication device 205. For example, the MMP 105a may support connections to an external camera 205m, a TV 205h, and an external LCD or LED display 205p. The MMP 105a may be communicatively coupled to the memory 205t and/or the external memory 205n.

In an exemplary embodiment of the invention, the MMP 205a may be operable to create a plurality of consecutive image frames for display on a display device such as, for example, the display device 215. The MMP 205a may be operable to divide each of the created consecutive image frames into a first portion and a corresponding second portion. In this regard, for example, the first portion may be an upper portion and the corresponding second portion may be a lower portion of an image frame. For each of the divided plurality of consecutive image frames, the first portion and the corresponding second portion may be transmitted, in a reversed order, to the display device 215 by the MMP 205a. Each of the divided plurality of consecutive image frames may be displayed on the display device 215 in the transmitted reversed order. Each of the divided plurality of consecutive image frames may be displayed beginning with one of the transmitted first portion and ending with one of the transmitted corresponding second portion. The MMP 205a may be operable to format each of the plurality of consecutive image frames to enable display of the consecutive image frames in an order in which they were transmitted, and to enable display of each of the divided plurality of consecutive image frames beginning with one of the first portion and ending with one of the corresponding second portion.

In an exemplary embodiment of the invention, the MMP 205a may be operable to determine how to divide each of the created consecutive image frames into the first portion and the corresponding second portion, based on user configuration of the multimedia communication device 205. The user configuration, which may be inputted or provided by a user of the multimedia communication device 205, may determine whether each of the created image frames may be divided into two portions, namely, the first portion and the corresponding second portion and/or how each of the created image frames may be divided proportionally.

The processor 205f may comprise suitable logic, circuitry, interfaces, and/or code that may be operable to control operations and processes in the multimedia communication device 205. The processor 205f may be operable to process signals from the RF block 205e and/or the MMP 205a.

The memory 205t may comprise suitable logic, circuitry, interfaces and/or code that may be operable to store information such as executable instructions, data and/or database that may be utilized by the processor 205f and the multimedia processor 205a. The memory 205t may comprise RAM, ROM, low latency nonvolatile memory such as flash memory and/or other suitable electronic data storage.

In operation, the multimedia communication device 205 may receive RF signals via the antenna 205d. Received RF signals may be processed by the RF block 205e and the RF signals may be further processed by the processor 205f. Audio and/or video data may be received from the external camera 205m, and image data may be received via the integrated camera 205g. During processing, the MMP 205a may utilize the external memory 205n for storing of processed data. Processed audio data may be communicated to the audio block 205s and processed video data may be communicated to the LCD or LED display 205b, the external LCD or LED display 205p and/or the TV 205h, for example. The keypad 205c may be utilized for communicating processing commands and/or other data, which may be required for image, audio or video data processing by the MMP 205a.

In an exemplary embodiment of the invention, the MMP 205a may be operable to create a plurality of consecutive image frames for display on a display device such as, for example, the display device 215. The MMP 205a may be operable to divide each of the created consecutive image frames into a first portion and a corresponding second portion. In this regard, for example, the first portion may be an upper portion and the corresponding second portion may be a lower portion of an image frame. For each of the divided plurality of consecutive image frames, the first portion and the corresponding second portion may be transmitted, in a reversed order, to the display device 215 by the MMP 205a. Each of the divided plurality of consecutive image frames may be displayed on the display device 215 in the transmitted reversed order. Each of the divided plurality of consecutive image frames may be displayed beginning with one of the transmitted first portion and ending with one of the transmitted corresponding second portion. The MMP 205a may be operable to format each of the plurality of consecutive image frames to enable display of the consecutive image frames in an order in which it was transmitted, and to enable display of each of the divided plurality of consecutive image frames beginning with one of the first portion and ending with one of the corresponding second portion. Accordingly, each of the displayed image frames which are displayed on the display device 215 may comprise a first portion and a corresponding second portion. The first portion of a displayed image frame may comprise a first portion of a created image frame which may be created at time T, for example. The corresponding second portion of the displayed image frame may then comprise a corresponding second portion of another created image frame which is consecutively created following or next to the image frame that is created at time T. In this regard, the corresponding second portion of a created image frame may be displayed on the display device 215 one frame ahead of the first portion.

In an exemplary embodiment of the invention, the MMP 205a may be operable to determine how to divide each of the created consecutive image frames into the first portion and the corresponding second portion, based on user configuration of the multimedia communication device 205. In this regard, each of the consecutive image frames created for display may comprise N lines of pixels, and each of the consecutive image frames displayed on the display device 215 may also comprise N lines of pixels, for example. Each of the first portions may comprise X lines of pixels and each of the corresponding second portions may comprise (N−X) lines of pixels, for example. X may be greater than zero and smaller than N. In an exemplary embodiment of the invention, X may be determined by the MMP 205a based on the user configuration of the multimedia communication device 205. For example, X may be determined based on a ratio of X to N (X/N). A ratio of X to N (X/N) may be equal to one quarter (¼), one third (⅓) or one half (½), for example.

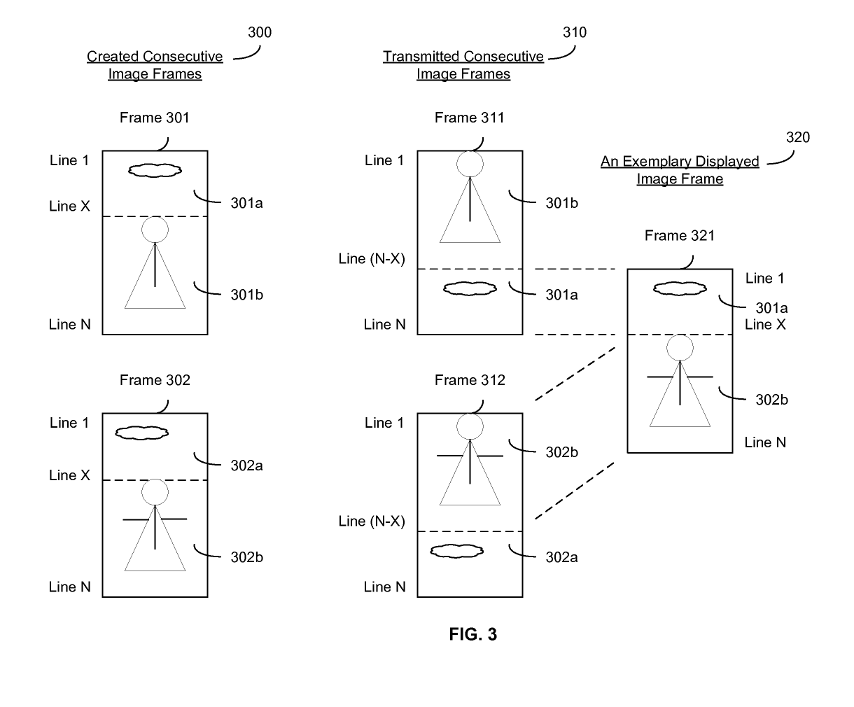

FIG. 3 is a block diagram illustrating an exemplary image frame which is displayed on a display device for reducing remote display latency, in accordance with an embodiment of the invention. Referring to FIG. 3, there is shown a plurality of created consecutive image frames 300, of which frame 301 and frame 302 are illustrated, a plurality of transmitted consecutive image frames 310, of which frame 311 and frame 312 are illustrated, and an exemplary displayed image frame 320, of which frame 321 is illustrated.

A plurality of consecutive image frames such as the frame 301 and the frame 302 may be created by the multimedia communication device 105 for display on a display device such as the display device 115. The frame 301 may be divided by the multimedia communication device 105 into a first portion 301a and a corresponding second portion 301b. The frame 302 may be divided by the multimedia communication device 105 into a first portion 302a and a corresponding second portion 302b. In this regard, for example, the first portion 301a may be an upper portion and the corresponding second portion 301b may be a lower portion of the frame 301. The first portion 302a may be an upper portion and the corresponding second portion 302b may be a lower portion of the frame 302. A plurality of consecutive image frames such as the frame 311 and frame 312 may be transmitted, for example, via the wireless communication network 103 to the display device 115. In this regard, during the transmission, the data stream of the frame 311 may comprise the first portion 301a and the corresponding second portion 301b in reversed order. The data stream of the frame 312 may comprise the first portion 302a and the corresponding second portion 302b in reversed order. An exemplary displayed image frame such as the frame 321 may be caused to display on the display device 115. In this regard, the frame 321 may begin with the first portion 301a of the frame 301 and end with the corresponding second portion 302b of the frame 302. Accordingly, the corresponding second portion 302b of the frame 302 may be displayed one frame ahead of the first portion 302a of the frame 302.

Each of the frames 301, 302, 311, 312, 321 may comprise N lines of pixels, for example. Each of the first portions 301a, 302a may comprise X lines of pixels and each of the corresponding second portions 301b, 302b may comprise (N−X) lines of pixels, for example. In this regard, X may be greater than zero and smaller than N. In an exemplary embodiment of the invention, X may be determined based on a ratio of X to N (X/N). A ratio of X to N (X/N) may be equal to one quarter (¼), one third (⅓) or one half (½), for example. In instances when N is equal to 1080, for example. Each of the frames 301, 302, 311, 312, 321 may comprise 1080 lines of pixels. For the case of X/N being equal to ¼, each of the first portions 301a, 302a may comprise 270 lines of pixels and each of the corresponding second portions 301b, 302b may comprise 810 lines of pixels. For the case of X/N being equals to ⅓, each of the first portions 301a, 302a may comprise 360 lines of pixels and each of the corresponding second portions 301b, 302b may comprise 720 lines of pixels. For the case of X/N being equals to ½, each of the first portions 301a, 302a may comprise 540 lines of pixels and each of the corresponding second portions 301b, 302b may comprise 540 lines of pixels.

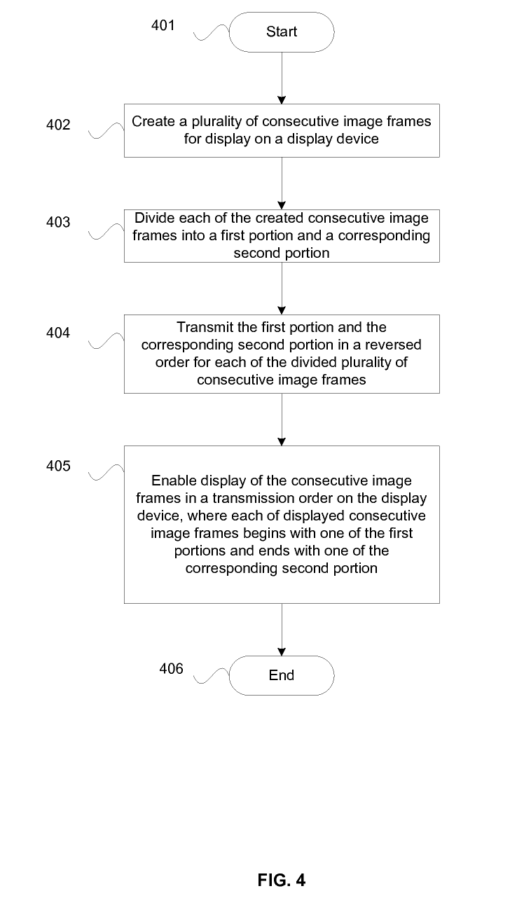

FIG. 4 is a flow chart illustrating exemplary steps for reducing remote display latency, in accordance with an embodiment of the invention. Referring to FIG. 4, the exemplary steps start at step 401. In step 402, the MMP 205a in the multimedia communication device 205 may be operable to create a plurality of consecutive image frames such as the frames 301, 302 for display on a display device 215. In step 403, the MMP 205a may be operable to divide each of the created consecutive image frames such as the frame 301 into a first portion 301a and a corresponding second portion 301b. In step 404, the MMP 205a may be operable to transmit the first portion such as the first portion 301a and the corresponding second portion such as the corresponding second portion 301b in a reversed order, for each of the divided plurality of consecutive image frames such as the frame 301, as illustrated in frame 311. In step 405, the MMP 205a may be operable to enable display of the consecutive image frames such as the frame 321 in a transmission order, on the display device 215. Each of displayed consecutive image frames such as the frame 321 begins with one of the first portions such as the first portion 301a and ends with one of the corresponding second portion such as the second portion 302b. The exemplary steps may proceed to the end step 406.

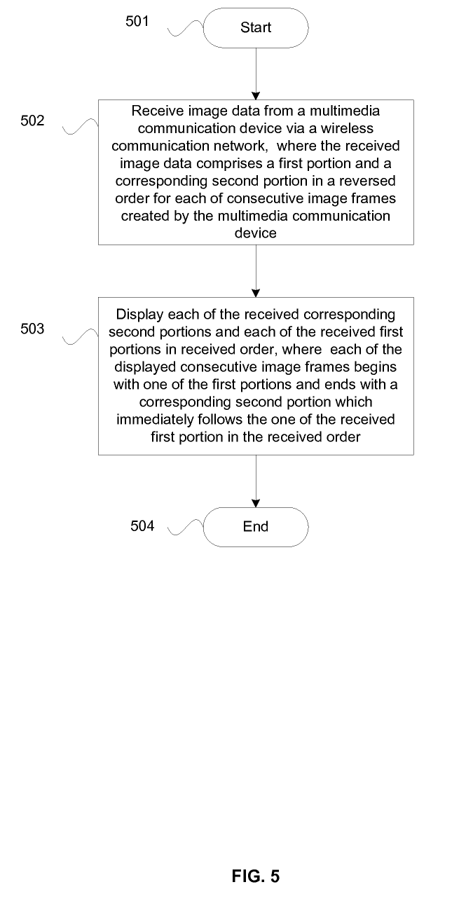

FIG. 5 is a flow chart illustrating exemplary steps for a display device to display received image data for reducing remote display latency, in accordance with an embodiment of the invention. Referring to FIG. 5, the exemplary steps start at step 501. In step 502, the display device 115 may be operable to receive image data from a multimedia communication device 105 via a wireless communication network 103. The received image data may comprise a first portion such as the first portion 301a and a corresponding second portion such as the corresponding second portion 301b in a reversed order, for each of consecutive image frames such as the frame 301 created by the multimedia communication device 105, as illustrated in the frame 311. In step 503, the display device 115 may be operable to display each of the received corresponding second portions 301b, 302b and each of the received first portions 301a, 302a in received order. Each of the displayed consecutive image frames such as the frame 321 begins with one of the first portions such as the first portion 301a and ends with a corresponding second portion such as the corresponding second portion 302b, which immediately follows the first portion 301a in the received order. The exemplary steps may proceed to the end step 504.

In various embodiments of the invention, a MMP 205a in the multimedia communication device 205 may be operable to divide each of a plurality of consecutive image frames such as the frame 301 into a first portion 301a and a corresponding second portion 301b. The plurality of consecutive image frames 301, 302 may be created for display, for example, on a display device 215. In this regard, for example, the first portion 301a may be an upper portion and the corresponding second portion 301b may be a lower portion of an image frame such as the frame 301. For each of the divided plurality of consecutive image frames such as the frame 301, the first portion 301a and the corresponding second portion 301b may be transmitted, in a reversed order, to the display device 215 by the MMP 205a, as illustrated in frame 311. Each of the divided plurality of consecutive image frames 311, 312 may be displayed on the display device 215 in the transmitted reversed order. Each of the displayed consecutive image frames, such as the frame 321, may be displayed beginning with one of the transmitted first portion such as the first portion 301a and ending with one of the transmitted corresponding second portion such as the corresponding second portion 302b. Accordingly, each of the displayed image frames which are displayed on the display device 215, such as the frame 321, may comprise a first portion and a corresponding second portion. The first portion of a displayed image frame 321 may comprise a first portion 301a of a created image frame 301 which may be created at time T, for example. The corresponding second portion of the displayed image frame 321 may then comprise a corresponding second portion 302b of another created image frame 302, which is consecutively created following the image frame 301 that is created at time T. The MMP 205a may be operable to format each of the plurality of consecutive image frames 301, 302 to enable display of the consecutive image frames in a transmission order, and to enable display of each of the divided plurality of consecutive image frames 311, 312 beginning with one of the first portion such as the first portion 301a and ending with one of the corresponding second portion such as the corresponding second portion 302b, as illustrated in the frame 321.

In an exemplary embodiment of the invention, the MMP 205a may be operable to determine how to divide each of the created consecutive image frames such as the frame 301 into the first portion 301a and the corresponding second portion 301b, based on user configuration of the multimedia communication device 205. In this regard, each of the consecutive image frames, such as the frame 301, created for display may comprise N lines of pixels, and each of the consecutive image frames, such as the frame 321, displayed on the display device 215 may also comprise N lines of pixels, for example, wherein N is an integer. Each of the first portions 301a, 302a may comprise X lines of pixels and each of the corresponding second portions 301b, 302b may comprise (N−X) lines of pixels, for example. X may be an integer that is greater than zero and smaller than N. In an exemplary embodiment of the invention, X may be determined based on the user configuration of the multimedia communication device 205. For example, X may be determined based on a ratio of X to N (X/N). A ratio of X to N (X/N) may be equal to one quarter (¼), one third (⅓) or one half (½), for example.

In an exemplary embodiment of the invention, the multimedia communication device 105 may be operable to transmit the divided plurality of consecutive image frames, such as the frames 311, 312, to the display device 115 via a wireless communication network 103. The wireless communication network 103 may comprise, for example, a WiFi network, a WiMAX network and/or a cellular network.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for reducing remote display latency.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing data, the method comprising:
in a multimedia communication device:
dividing each of a plurality of consecutive image frames, which are created for presentation on a display device, into a first portion and a corresponding second portion; and
for each of said divided plurality of consecutive image frames, transmitting said first portion and said corresponding second portion in a reversed order to said display device, wherein:
each of said divided plurality of consecutive image frames is displayed in said transmitted reversed order; and
each of said divided plurality of consecutive image frames is displayed beginning with one of said transmitted first portion and ending with one of said transmitted corresponding second portion.

2. The method according to claim 1, comprising determining how to divide each of said created consecutive image frames into said first portion and said corresponding second portion based on user configuration of said multimedia communication device.

3. The method according to claim 1, wherein each of said created consecutive image frames comprises N lines of pixels, and each of said displayed consecutive image frames displayed on said display device comprises N lines of pixels, where N is a positive non-zero integer that is greater than 1.

4. The method according to claim 3, wherein said first portion comprises X lines of pixels and said corresponding second portion comprises (N−X) lines of pixels, where X is a positive non-zero integer.

5. The method according to claim 4, wherein a value of X is less than said N.

6. The method according to claim 4, determining a value of X based on user configuration of said multimedia communication device.

7. The method according to claim 6, wherein a ratio of X to N is one quarter.

8. The method according to claim 6, wherein a ratio of X to N is one third.

9. The method according to claim 6, wherein a ratio of X to N is one half.

10. The method according to claim 1, comprising transmitting said divided plurality of consecutive image frames to said display device via a wireless medium.

11. A system for processing data, the system comprising:
one or more processors and/or circuits for use in a multimedia communication device, said one or more processors and/or circuits being operable to:
divide each of a plurality of consecutive image frames, which are created for presentation on a display device, into a first portion and a corresponding second portion; and
for each of said divided plurality of consecutive image frames, transmit said first portion and said corresponding second portion in a reversed order to said display device, wherein:
each of said divided plurality of consecutive image frames is displayed in said transmitted reversed order; and
each of said divided plurality of consecutive image frames is displayed beginning with one of said transmitted first portion and ending with one of said transmitted corresponding second portion.

12. The system according to claim 11, wherein said one or more processors and/or circuits are operable to determine how to divide each of said created consecutive image frames into said first portion and said corresponding second portion based on user configuration of said multimedia communication device.

13. The system according to claim 11, wherein each of said created consecutive image frames comprises N lines of pixels, and each of said displayed consecutive image frames displayed on said display device comprises N lines of pixels, where N is a positive non-zero integer that is greater than 1.

14. The system according to claim 13, wherein said first portion comprises X lines of pixels and said corresponding second portion comprises (N−X) lines of pixels, where X is a positive non-zero integer.

15. The system according to claim 14, wherein a value of X is less than said N.

16. The system according to claim 14, wherein said one or more processors and/or circuits are operable to determine a value of X based on user configuration of said multimedia communication device.

17. The system according to claim 16, wherein a ratio of X to N is one quarter.

18. The system according to claim 16, wherein a ratio of X to N is one third.

19. The system according to claim 16, wherein a ratio of X to N is one half.

20. The system according to claim 11, wherein said one or more processors and/or circuits are operable to transmit said divided plurality of consecutive image frames to said display device via a wireless medium.

21. A method for processing data, the method comprising:
in a multimedia communication device:
dividing each of a plurality of consecutive image frames, which are created for presentation on a display device, into a first portion and a corresponding second portion;
formatting each of said plurality of consecutive image frames to enable display of said consecutive image frames in a transmission order, and to enable display of each of said divided plurality of consecutive image frames beginning with one of said first portion and ending with one of said corresponding second portion; and
for each of said divided plurality of consecutive image frames, transmitting said first portion and said corresponding second portion in a reversed order to said display device.

22. A system for processing data, the system comprising:
one or more processors and/or circuits for use in a multimedia communication device, said one or more processors and/or circuits being operable to:
divide each of a plurality of consecutive image frames, which are created for presentation on a display device, into a first portion and a corresponding second portion;
format each of said plurality of consecutive image frames to enable display of said consecutive image frames in a transmission order, and to enable display of each of said divided plurality of consecutive image frames beginning with one of said first portion and ending with one of said corresponding second portion; and
for each of said divided plurality of consecutive image frames, transmit said first portion and said corresponding second portion in a reversed order to said display device.
